(19) United States
(12) Patent Application Publication
(10) Pub. No.: US 2020/0184492 A1
(43) Pub. Date: Jun. 11, 2020

(54) Myleadsupplier

(71) Applicant: Jose Friman, West Palm Beach, FL (US)

(72) Inventor: Jose Friman, West Palm Beach, FL (US)

(21) Appl. No.: 16/591,923

(22) Filed: Oct. 3, 2019

Related U.S. Application Data
(60) Provisional application No. 62/777,773, filed on Dec. 11, 2018.

(51) Int. Cl. G06Q 30/02; G06Q 30/00; G06Q 40/08

(52) U.S. Cl. CPC G06Q 30/0201; G06Q 40/08; G06Q 30/01

(57) ABSTRACT

This disclosure relates generally to the methods and systems are presented for assessing sales leads obtained through a lead generation product. One exemplary method comprises receiving consumer information from a potential consumer via a lead generation product; receiving activity information about the potential consumer's interaction with the lead generation product; using the received consumer information and received activity information to develop one or more category scores; and developing a sales lead quality score from the one or more category scores. When a lead comes from vendors our platform contact them and connect the agent that looking to buy leads. Our platform also sends emails and text messages to get the lead connected to our platform and other insurance agents. Another uniqueness of our system that will call the lead and get the lead associated with a representative.

### CROSS-REFERENCE TO RELATED APPLICATIONS

This application claims priority to the following U.S. Provisional Patent Application, of which is hereby incorporated by reference in its entirety: U.S. Ser. No. 62/777,773 filed on 11 Dec. 2018.

### FIELD OF THE INVENTION

Aspects of the present invention relate more particularly to the field of Lead Generation Industry.

### TECHNICAL FIELD

The present invention pertains to systems, methods, and processes for enabling businesses to determine, communicate, and manage their credibility. It also sends out emails and text messages to get the lead connected to our platform and other insurance agents. Another important features of our system will call the lead and get the lead connected with a representative.

### DESCRIPTION OF THE RELATED ART

On a daily basis millions of consumers are online looking for properties, products, and/or services. Consequently these millions of consumers represent potential sales leads that sellers and advertisers have an interest in approaching in the hope of making a sale. A lead may be thought of as a potential customer of an advertised property, product, or service where that potential customer has expressed some interest in the advertised item and has initiated some form of contact with a sales agent or advertiser associated with that item of interest (even if the contact is anonymous). Thus, a person who contacts a real estate agent, apartment community, or service provider by sending an email inquiry about one or more properties or services that he or she may have seen online represents a lead. Millions of such leads are generated via online activities by potential consumers each day. However, only a very small percentage of this activity actually results in the sale of a property, product, or service.

### SUMMARY

In light of the disadvantages of the prior art, the following summary is provided to facilitate an understanding of some of the innovative features unique to the present invention and is not intended to be a full description. A full appreciation of the various aspects of the invention can be gained by taking the entire specification, claims, drawings, and abstract as a whole.

The primary object of the invention is to provide currently available lead generation products take information that is provided by the consumer to rate and rank a lead. However, knowledge of a particular industry may also be utilized to develop various scores for categories of interest-such as relevancy, engagement, and immediacy—to assess the potential readiness of a consumer to make a purchase. For example, for consumers obtaining information about a product from a Web site, these scores and this readiness assessment may be developed based on, among other things, the consumer's activity on the site, how the consumer arrived at the site, as well as the information provided by the consumer while at the site.

Another object of the invention is the Systems and methods for assessing sales leads obtained through a lead generation product are disclosed. For example, in certain embodiments a method comprises receiving consumer information from a potential consumer via a lead generation product, such as, for example, a Web site. In addition, activity information about the potential consumer's interaction with the lead generation product is also received. The received consumer information and received activity information is used to develop one or more category scores. One or more category scores are then used to develop a sales lead quality score.

Another object of the invention is to a lead quality score with respect to a potential sales lead can be created. The lead quality score can be based on one or more areas of interest, such as relevancy, engagement and immediacy, and a separate score can be created for each area of interest. Relevancy can be the closeness of a product or service match to what the user is looking for. Engagement can be the interest of the user in finding a product or service.

Immediacy can be the urgency of finding a product or service for the user.

### DETAILED DESCRIPTION

In accordance with one aspect, the invention provides a method for presenting sales lead information to a sales agent using the internet, the method comprising inputting sales leads, having sales lead information, into a sales lead system, the sales lead system identifying an assigned sales agent to work the lead; transmitting the lead information to a web based lead system, which is associated with the assigned agent; accessing the lead information, by the assigned sales agent, by accessing the web based lead system; and presenting the lead information to the assigned sales agent using an agent processor by transmitting the lead information from the web based lead system to the agent processor, the lead information including dispositioning information, agent note information and source of sale information.

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

The present invention provides systems and methods for processing sales leads. Illustratively, the invention provides a method for presenting sales lead information to a sales agent using the internet, the method comprising: inputting sales leads, having sales lead information, into a sales lead system, the sales lead system identifying an assigned sales agent to work the lead; transmitting the lead information to a web based lead system, which is associated with the assigned agent; accessing the lead information, by the assigned sales agent, by accessing the web based lead system; and presenting the lead information to the assigned sales agent using an agent processor by transmitting the lead information from the web based lead system to the agent processor, the lead information including dispositioning information, agent note information and source of sale information.

While a specific embodiment has been shown and described, many variations are possible. With time, additional features may be employed. The particular shape or configuration of the platform or the interior configuration may be changed to suit the system or equipment with which it is used.

Having described the invention in detail, those skilled in the art will appreciate that modifications may be made to the invention without departing from its spirit. Therefore, it is not intended that the scope of the invention be limited to the specific embodiment illustrated and described. Rather, it is intended that the scope of this invention be determined by the appended claims and their equivalents.

1. A method for presenting sales lead information to a sales agent using the internet, the method comprising:
inputting sales leads, having sales lead information, into a sales lead system, the sales lead system identifying an assigned sales agent to work the lead;
transmitting the lead information to a web based lead system, which is associated with the assigned agent;
accessing the lead information, by the assigned sales agent, by accessing the web based lead system;
When we receive the lead, from our landing page, or lead that we bought, our unique system calls them, and ask to get connected to the insurance agent, if the lead doesn't pick up the phone, the system sends them a text message and emails so they can schedule a phone call. Once the call is scheduled, the system automatically calls to get connected;
our system will call the lead and get the lead connected with a representative;
Our platform also sends emails and text messages to get the lead connected to our platform and other insurance agents.
